(19) United States
(12) Patent Application Publication
(10) Pub. No.: US 2012/0307252 A1
(43) Pub. Date: Dec. 6, 2012

(54) RECYCLED LIGHT INTERFEROMETRIC FIBER OPTIC GYROSCOPE

(75) Inventors: John D. Moores, Groton, MA (US); Farhad Hakimi, Watertown, MA (US); Don M. Boroson, Needham, MA (US)

(73) Assignee: Massachusetts Institute of Technology, Cambridge, MA (US)

(21) Appl. No.: 13/307,534

(22) Filed: Nov. 30, 2011

Related U.S. Application Data
(60) Provisional application No. 61/437,053, filed on Jan. 28, 2011.

(51) Int. Cl. G01C 19/72

(52) U.S. Cl. 356/460

(57) ABSTRACT

Interferometric fiber optic gyroscope. The gyroscope includes a pulsed light source for generating light pulses and a sense coil for receiving and trapping the light pulses travelling in clockwise and counter clockwise directions for a selected number of times around the sense coil. A detector receives the counter propagating light pulses to determine the phase shift between the two counter propagating light pulses, the phase shift being proportional to rotation rate of the sense coil.

This application claims priority to provisional application Ser. No. 61/437,053 filed on Jan. 28, 2011. The contents of this provisional application are incorporated herein by reference.

This invention was made with government support under contract number FA8721-05-C-002, awarded by the U.S. Air Force. The government has certain rights in this invention.

### BACKGROUND OF THE INVENTION

This invention relates to fiber optic gyroscopes and more particularly to a fiber optic gyroscope that recycles the optical beam around a sense loop.

Fiber optic gyroscopes (FOG) constitute an important class of rotation sensors for many navigation and pointing applications. There are a few variations of FOGs. They include the interferometric fiber optic gyroscope (IFOG), resonating fiber optic gyroscope (RFOG), and fiber-optic ring laser gyroscope (RLG). IFOGs outperform (noise and drift characteristics) other types of FOG by orders of magnitude. IFOG performance improves linearly with the net projection of the physical area enclosed by the propagating light that is parallel to the plane of the rotation to be sensed. In a typical IFOG design, this projected area is directly proportional to the physical length of the sensor optical fiber. The present invention is germane to significant improvement of IFOG performance without increasing the physical length of fiber by recycling the optical beam around the sense loop. Furthermore, gyro drift is reduced by repeated polarization filtering of the recycled light around the loop.

IFOG senses rotation based on the Sagnac effect. Briefly, the Sagnac effect is a phase shift that occurs between two counter propagating electromagnetic waves in a ring interferometer when the interferometer is rotating. For a coil of diameter D and fiber ength L, the Sagnac shift is given by Ω*(2πLD)/cλ, where c is speed of light, λ is centroid of optical wavelength, and Ω rotation rate as shown in FIG. 1. The (2πLD)/cλ term is the Sagnac gain, which is a measure of gyro sensitivity to rotation. The main takeaway from the Sagnac gain expression is that IFOG sensitivity scales linearly with the length of the sense fiber.

FIG. 2 shows a conventional IFOG in a so-called minimum configuration. It consists of a constant intensity broadband light source, an optical detector, a polarizer, two couplers, a phase modulator, and a fiber sense coil. In an IFOG the light from a source is divided by a 2×2 coupler and launched in the fiber sense coil in clockwise and counter-clockwise directions. The two counter propagating light beams in the coil are combined by the same 2×2 coupler to form an interference fringe which is detected by the optical detector. The role of phase modulator is to bias the interferometer in the quadrature point (maximum slope) and reduce receiver noise through synchronous detection. The polarizer ensures that only one single mode of the sensor is monitored (out of two polarization modes).

High performance IFOG rotation rate sensors of moderate size have been demonstrated with angle random walk (ARW) and bias instability (BI) of less than 10⁻⁴ deg/hr^{1/2} and 10⁻⁴ deg/hr, respectively. IFOG instruments with ARW and BI of 10⁻⁴ deg/hr^{1/2} and 3×10⁻⁴ deg/hr are commercially available. The length of the fiber used in the above high performance IFOGs is of the order of a few km, which requires large coil sizes (˜7″ in diameter).

### SUMMARY OF THE INVENTION

The interferometric fiber optic gyroscope, according to the invention, includes a pulsed light source for generating light pulses and a sense coil for receiving and trapping the light pulses travelling in clockwise and counter clockwise directions for a selected number of times around the sense coil. A detector receives the counter propagating light pulses to determine the phase shift between the two counter propagating light pulses, the phase shift being proportional to rotation rate of the sense coil. In a preferred embodiment, the interferometric fiber optic gyroscope includes a 2×2 coupler for receiving the light pulses and launching clockwise and counter clockwise beams into the sense coil. This embodiment also includes at least one optical switch for switching the light pulses into and out of the sense coil. A suitable optical switch is an electro-optic switch. In yet another embodiment of the invention, the detector is time gated.

In yet another embodiment of the invention an additional optical switch or variable optical attenuator is provided in the sense coil to suppress unwanted leakage light in the sense coil. The light pulses in the sense coil may be multiplexed such as with time multiplexing or wavelength multiplexing. The light pulses may be both time and wavelength multiplexed. In a particularly preferred embodiment, the gyroscope components of the invention are integrated onto an optical chip.

### BRIEF DESCRIPTION OF THE DRAWING

FIG. 1 is a schematic illustration showing the Sagnac effect.

FIG. 2 is a prior art conventional interferometric fiber optic gyroscope in minimum configuration.

FIGS. 3a and 3b are schematic illustrations of embodiments of the invention disclosed herein.

FIG. 4 is an embodiment of the invention with an added optical switch within the sense coil.

FIGS. 5a and b are schematic illustrations of an on-chip implementation of the recycled light interferometric fiber optic gyroscope according to embodiments of the invention.

FIG. 6 is a schematic illustration of a recycled light interferometric fiber optic gyroscope in a tethered configuration.

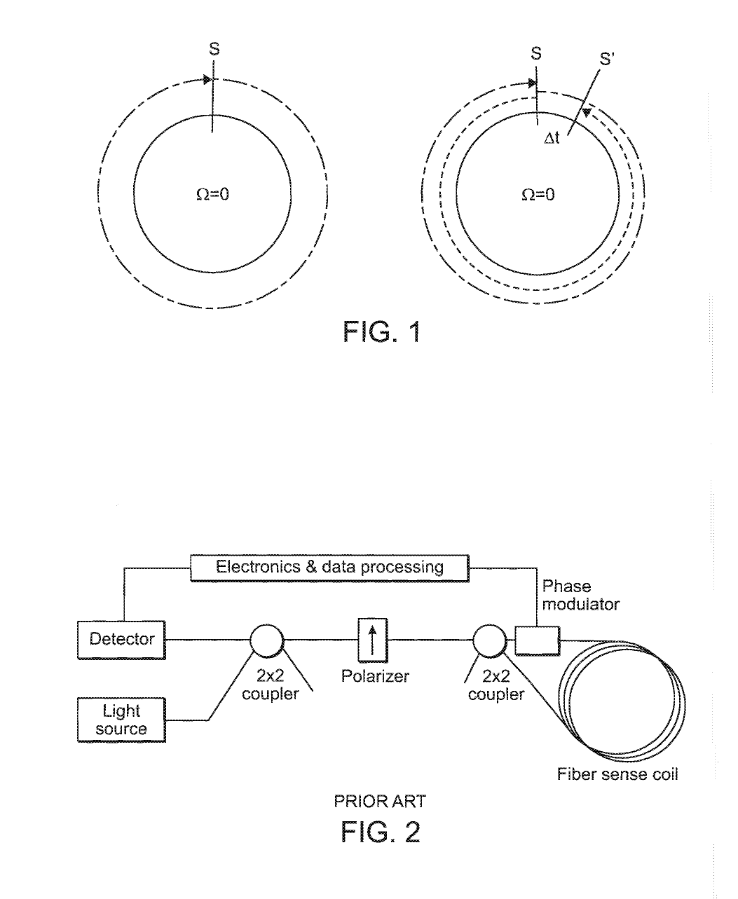

### DESCRIPTION OF THE PREFERRED EMBODIMENT

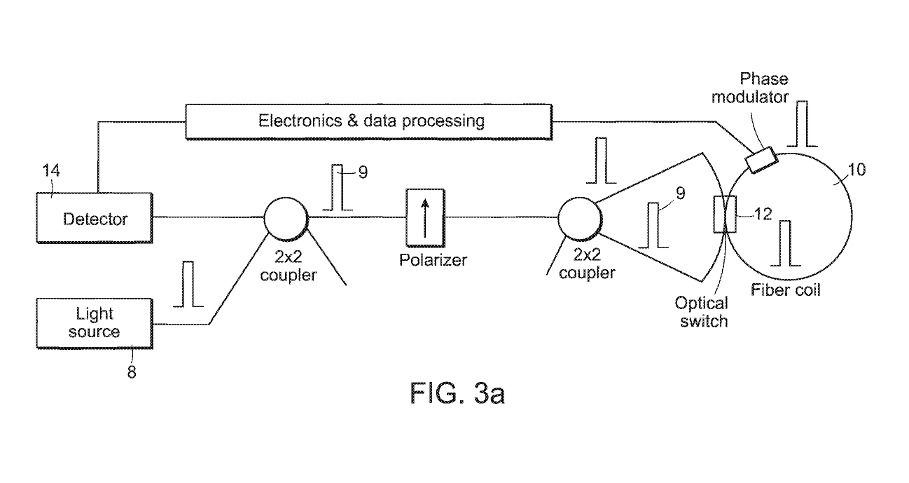

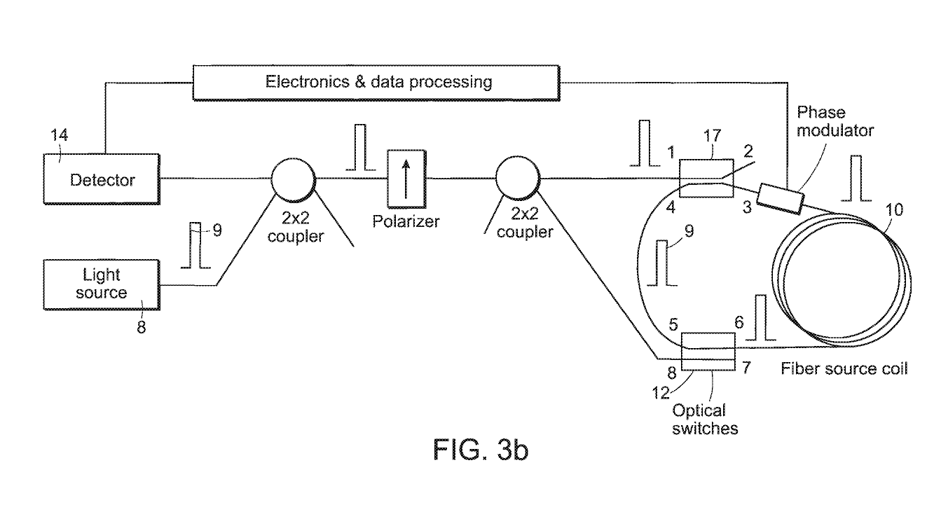

A key observation of this application is that the sensor fiber length can be reduced significantly, without reduction in performance, by recycling light around the sense loop. The modified IFOG uses a pulsed source 8 in contrast to constant intensity light in a conventional IFOG. With reference to FIGS. 3a and 3b, the optical pulses 9, after entering the sense coil 10, are trapped in the sense coil 10 recirculating loop by appropriate driving of the optical switch(es) 12. The pulse trapping in the loop occurs for both clockwise and counterclockwise directions. After going around the loop for a predetermined number of times, N, the light pulses are switched so that they exit the sense coil 10, pass through a chain of components, and are received by the detector 14. Since the time of flight between the source and the detector is preset and deterministic, the detector 14 can be time gated so as to accept light only during the time intervals when the signal pulses are arriving, thereby rejecting optical noise that propagates in between the signal pulses. The time gating can be a physical activation of the detector only during the interval when a signal pulse is present, or the time gating could be performed in post-processing (in hardware or software or firmware) following the detection. The recycled light experiences the Sagnac effect N times where N is the number of circulations of a pulse around the loop, hence N times more sensitivity can be achieved as compared to an IFOG with the same length fiber. FIGS. 3a and 3b show one- and two-optical switch 12 implementations of a recycled light IFOG.

In a preferred embodiment, the switch(es) 12 is/are electro-optic (EO) switches, which have advantages of relatively low insertion loss and fast switching speeds (rise and fall times). Furthermore, many EO switches also pertain a polarizing function regardless of the switching state of the devices, and this polarizing effect is beneficial for IFOG performance. EO switches vary greatly in terms of achievable extinction ratio (ER), or ability to extinguish light, and the achievable ER can influence choice of operational modes.

The noise in conventional IFOGs has three major components, optical shot noise, electronics, and optical relative intensity noise (RIN). Optical shot noise decreases inversely with square root of average received optical power, electronics noise decreases inversely with average optical power, and RIN is optical power independent. Since the modified IFOG has the same noise contributions as the conventional IFOG, there is no noise penalty due to the pulsed light source 8, as long as the average received optical power remains the same.

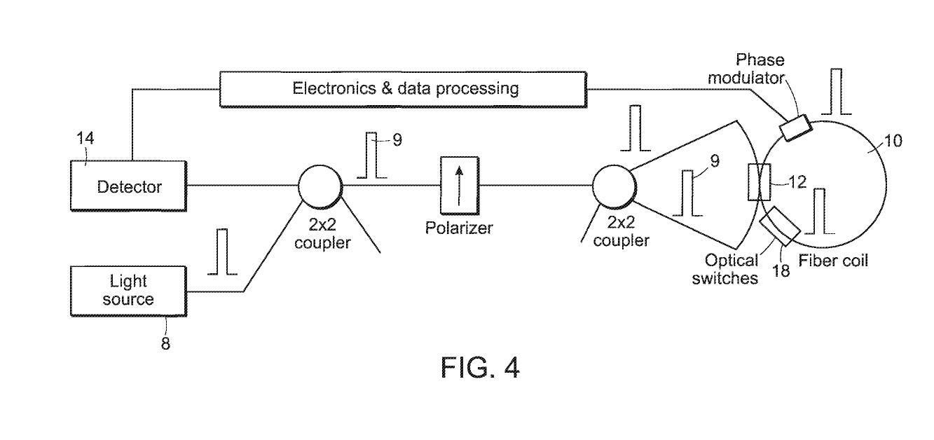

FIG. 4 shows an embodiment of the present invention with an optical switch (or variable attenuator) 18 in the sense coil 10 in order to suppress the unwanted parasitic optical pulses. Specifically, during the ordinary operation of the device, pulses are coupled into the fiber sense coil 10, circulate N times, and are then switched out of the coil. However, optical switches are not perfect and some of the light that was inside the loop remains after the switching operation. An extra switch, or a variable optical attenuator (VOA) 18, can be added to the sense coil 10 and activated at certain times in order to suppress unwanted leakage light in the coil (the figure depicts an optical switch, but a fast VOA could be suitable).

Referring still to FIG. 4, as another alternative, or in addition to this mechanism, the optical switch(es) 12 that are used to couple light into and out of the sense coil 10 can be placed in the cross-switching state during a particular time window for more than one consecutive roundtrip in order to improve the extinction of leakage light.

As an example of the impact of extinction ratio on performance, consider the device depicted in FIG. 4. Suppose the switch 12 has a 2 dB insertion loss and a 19 dB switching extinction ratio. Suppose a 20 dBm (100 mW) peak signal is injected into the loop (20 dBm inside the loop, higher prior to injection into the loop since the switch imposes insertion loss). Suppose we choose N=10 roundtrips. If we can neglect dispersion of the signal pulse (likely, especially for sub-km propagation distances), the peak of the signal will be attenuated to 0 dBm after N=10 roundtrips. After switching the signal out of the loop, the residual signal in the loop will be −21 dBm. If while switching out the signal pulse we inject a new signal pulse at 20 dBm, and if we assume that the residual prior signal is the dominant “noise” source for the new signal pulse, then we can expect a signal to noise ratio (SNR) of [20 dBm−(−21 dBm)]=41 dB, which is a healthy and respectable SNR.

Continuing the example, in the unlikely event that this 41 dB SNR were inadequate, then instead of switching in a new signal pulse at the time that we switch out the old signal pulse, we could instead wait one roundtrip to switch in the new pulse. At the time that we switch in the new signal pulse, we will automatically switch out the residual old signal pulse (assuming the 130 pulses do not walk off relative to each other). Thus the new pulse is at 20 dBm, but the residual old signal pulse will drop to −21 dBm-19 dB (switching extinction)−2 dB (insertion loss)=−42 dBm. The SNR in the loop would then be [20 dBm−(−42 dBm)]=62 dB, which would be an exceptionally good SNR.

If even that SNR were inadequate, one could consider the device of FIG. 4, and during the time between the switching out of the old signal pulse and the switching in of the new pulse, the internal loop switch or VOA 18 could be set to switch out or attenuate the residual old signal pulse even more, perhaps another 19 dB or more.

Up to this point in the description of the recycled FOG, we have generally treated the optical pulse width as comparable to but less than the propagation time around the sense coil, so that at most only a single pulse is recirculating in the sense coil at any time. The pulse in the sense coil will in fact be shorter than the loop propagation time because of the rise and fall time of the optical switch used to inject and extract pulses. One disadvantage of using a single pulse in the loop is that the delay between measurements of rotation rate will be at least N (number of sense coil recirculations) times the sense coil propagation time. For a 100 m sense coil of average index of refraction 1.5, the delay between measurements will be (1.5) (1000 m)/(3×10⁸ m/s)=5 μs. For many applications, such a delay between measurements would not impose a limitation.

If there were an application that would require or benefit from an output sample delay less than N times the sense coil roundtrip delay, we can time multiplex pulses in the sense coil. One method is time division multiplexing. We can think of the light propagating in one direction around the sense coil as being divided into M equal duration subintervals. This implies that the pulse widths must be shorter by at least a factor of M than in the single-pulse-per-sense-coil case. Let the duration of one such propagation subinterval be denoted T. Then the sense coil propagation time is MT, and for the single pulse case described above, the delay between measurement samples is NMT. Let us number the M recirculating time intervals j=0, 1, 2, . . . , (M−1). The idea is that we can inject pulses and read out pulses from the loop at different times, more frequently than we could with a single pulse per sense coil. In typical scenarios where IFOG output samples are averaged over time intervals much longer than N roundtrip times (NMT), this approach may not provide an advantage over using a single loop-filling pulse every NMT. This approach might be advantageous in situations in which the time scales of the dynamics being measured are faster than NMT but comparable to MT. This scenario could be more relevant if an extremely low-loss sense coil material were to be discovered and the loop length could be increased.

Let's begin with a simple example of time multiplexing with M=3 and N=4. At time t=0, we inject a pulse into the j=0 interval. We wait 4/3 (=N/M) roundtrips and at t=(N/M)(MT)=4MT/3, we inject a second pulse into the loop, in the j=1 (=4 mod 3=N mod M) interval. We wait another 4/3 roundtrip and at t=8MT/3, we inject a pulse into the j=2 (=8 mod 3=2N mod M) time interval. At this point the loop is filled—three pulses in three intervals. At time t=4MT, we read out of the j=0 interval and write in a new signal pulse. We wait another 4/3 roundtrip and at t=16MT/3, we read out and write into the j=1 interval, and so forth. From time t=4MT onwards (after the initial loading of the loop), we achieve a 3×(Mx) reduction in delay between measurements—we are able to read out a pulse every 4MT/3, vs. 4MT for the single pulse per loop case, yet we still reap the benefits of having each pulse recirculate N=4 times.

Next consider an example with M=7 and N=4, where, unlike the previous example, M>N. At time t=0, we inject a pulse into the j=0 interval. We wait 4/7 (=N/M) roundtrips and at t=(N/M)(MT)=4MT/7, we inject a second pulse into the loop, in the j=4 interval. We have not waited more than a roundtrip as in the previous example, but have injected two pulses during a single roundtrip. We continue periodic injection, and at t=8MT/7 inject a pulse into the j=1 (=8 mod 7=2N mod M) interval. At t=12MT/7, we inject in j=5. At t=16MT/7, we inject in j=2. At t=20MT/7, we inject in j=6. At t=24MT/7, we inject into j=3. At this point the loop is full. We read out the j=0 interval at time t=28MT/7=4MT=NMT and inject a new signal pulse in j=0. At time 32MT/7, we read from and write to j=4, etc. We are reading out pulses M=7 times more frequently than we would if we injected only a single pulse into the loop at any time.

Any M and N could be selected, but in general, the read/write intervals would not always be evenly spaced in time. For simplicity of the hardware design, it may be desirable to choose M and N such that pulses are read and written at a fixed repetition rate. We can determine the criteria on M and N such that pulses are injected and read out at regular intervals. Let us first assume that the read and write operations for interval j are simultaneous. In the two examples given above, M and N were chosen to be coprime (relatively prime), and we chose the read/write interval to be (N/M) times the loop roundtrip time. This ensures that we only read out from (and write to) a particular interval in the loop every N (=M*N/M) roundtrips, yet we are able to read out a pulse every N/M roundtrip times. If N and M shared a common factor greater than one, say K, then we can only write M/K pulses into the loop before we start reading out of the loop again. Therefore each pulse only propagates around the loop for N/K roundtrips. Thus, if we require period reads/writes and insist on simultaneous reads/writes, we should select M and N to be coprime and we should chose the read/write interval to be (N/M) times the roundtrip. If N is chosen to be a prime number, then we can choose M to be any positive integer greater than 1 (M=1 is the case of a single pulse per roundtrip—no speedup in readout from multiplexing) other than a multiple of N, to ensure than M and N are coprime. Technically, this is equivalent to the fact that the cyclic group formed by the integers 0, 1, . . . (N−1) under addition forms a cyclic group and it will have no cyclic subgroups if N is prime, or equivalently if Φ(N)=N, where Φ(.) is the Euler totient function. That is, any positive integer less than N is a generator of the group. If N is not prime, then we must factor N and make sure that any M we choose is not divisible by any of those factors. There are exactly Φ(N) (which is <N for N composite) integers less than N and coprime to N, but as pointed out above, the case of M=1 provides no delay reduction in the readout interval. M need not be less than N, but it must be coprime to N. Choosing N prime provides the greatest flexibility in the choice of M. The larger the prime N, the greater is the flexibility in the choice of M.

Next we consider the case in which we periodically read and write, but we do not simultaneously read and write in the same interval j. This could be motivated by SNR considerations, where we need to extinguish residual signal light in the sense coil after readout. Instead, we wait Q roundtrips after reading from interval j before we write into interval j. In order for the reads and writes to be periodic, this requires waiting a multiple of N roundtrip times between the read operation and the write operation, or Q=qN, where q is a positive integer. In the case q=0 (no delay between read and write) discussed above, each interval of the loop is always 215 filled. For q>0, the loop fill fraction is only 1/(1+q). This also implies that instead of a factor of M speedup in readout relative to the one-pulse-per-loop case (M=1, Q=0), we obtain only a factor of M/(1+q) speedup. The read/write interval is now (N+Q)/M=(N/M)(1+q) roundtrips.

Thus far, the discussion has focused on time multiplexing of pulses in the sense coil. This requires using pulses M times shorter than for the 1-pulse-per-loop case. Another alternative is to use wavelength multiplexing, which does not necessarily require shorter pulses in time. One embodiment uses a fast, nonabsorptive, tunable wavelength filter instead of an optical switch as the interface to the sense coil. The filter is designed to pass one wavelength band but to reflect all other wavelengths. At the time when the loop is to be read or loaded at a particular wavelength, the filter is tuned to that wavelength, enabling the stored pulse to come out of the loop and the 225 new signal pulse to be written into the loop. All other wavelengths are reflected by the filter, so that any other wavelengths already stored in the loop remain in the loop. If during a particular interval no writing or reading is to be performed, the filter can be tuned to a wavelength other than the wavelengths used for pulses. Although the transmitter may be more complicated using wavelength multiplexing, since we need multiple lasers or a tunable laser, there may be some 230 advantages. In particular, the insertion loss of the tunable filter that provides the readout/write capability for the sense coil may have lower insertion loss than an optical switch. This may enable the use of larger N. However, a drawback of this approach, if the pulses are all of long duration so that they overlap in time, is that the rejection requirement for the filter becomes more difficult. For example, if the filter only provides 20 dB rejection of each other wavelength, and if there are 10 other wavelengths, and if we assume each pulse peak power is the same=P, then the signal out is approximately P, but the leakage of all the other wavelengths is additive and equal to 10(P/100)=P/10, for a somewhat poor SNR of 10. This may require a second tunable filter in front of the detector, slaved to the sense coil tunable filter, to improve rejection.

As was indirectly suggested above, another alternative is a combination of time and 240 wavelength multiplexing. With this approach, we obtain the flexibility in readout rates vs. storage times of time multiplexing, and the potential for the reduced insertion loss of the fast tunable filter relative to the optical switch (although the tunable filter may not be as fast as the optical switch).

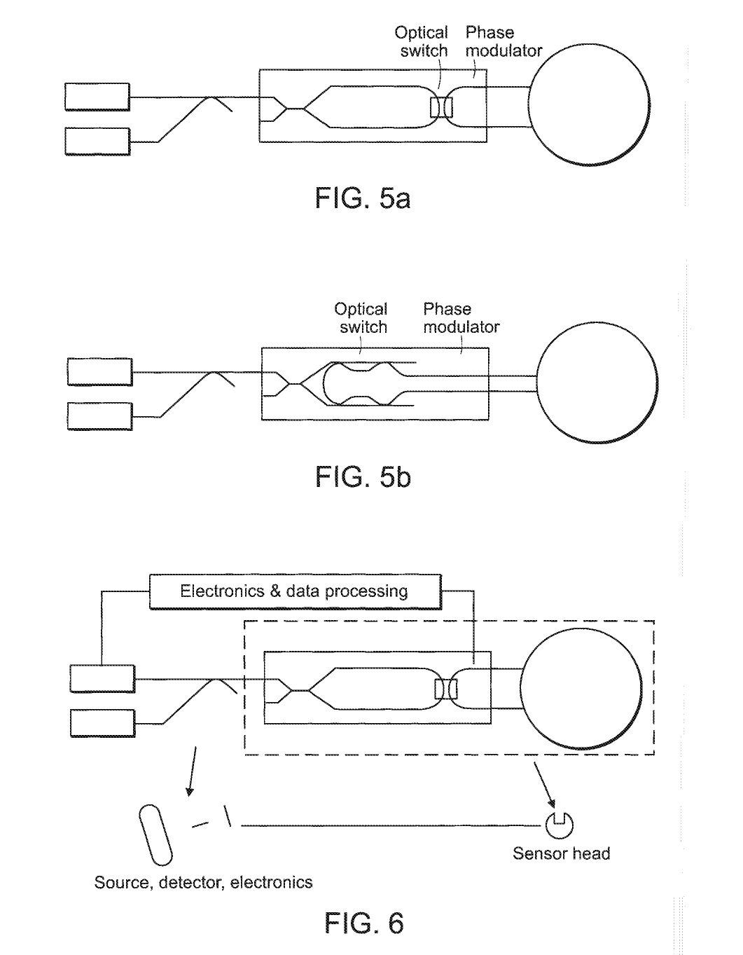

FIGS. 5a,b show two embodiments of an integrated recycled light IFOG where the optical switches, phase modulator, and a phase modulator are placed on an optical chip. An example of an optical chip platform would be proton exchange Lithium Niobate (LiNbO₃). A proton exchange LiNbO₃ chip has an added advantage that it propagates only one state of polarization which makes it an effective polarizer. One of main sources of drift in a FOG (bias instability) is polarization cross coupling. The recycled light around the loop is re-polarized each time it passes through a portion of the optical chip, and cross polarized light is filtered out each time it travels in the chip. Therefore, a major advantage of an integrated recycled light IFOG is lower gyro drift due to reduced polarization cross coupling.

Generally the FOG instruments are stand-alone single module units. However, there is a benefit in separating the sense coil from the optical source and detector in a tethered configuration, in order to reduce size and weight of the sensor head. A preferred embodiment tethered configuration is illustrated in FIG. 6 where the sense coil together with an optical chip is placed away from the source, detector, and electronics of the recycled light IFOG. This configuration has the added advantage of keeping the parasitic heat sources (electronics and optical source etc.) away from the sensor head.

Another configuration is possible in which the integrated optical chip is also remote from the sense coil, but in this configuration it is important to ensure that the contribution to the measured rotation signal from the section of fiber connecting the optical chip to the sense coil is kept to a minimum. The optical fibers connecting the optical chip and the sense coil could be kept as close as possible, could be twisted, or could otherwise be arranged so that the contributions from this region cancel each other as well as possible.

Besides electro-optic optical switches regarding the current invention, there are other potential candidates such as acousto-optic modulators (AOMs)^{1,2}, and magneto-optic³, thermo-optic^{4,5}, and opto-mechanical switches. Electro-optic switches are chosen for preferred embodiments because of their extremely fast switching rise and fall times, their relatively low insertion loss, the polarizing property of many EO modulators, lack of moving parts (in contrast to electro-mechanical) and the low electrical drive power required compared to acousto-optic technologies. The superscript numbers refer to the referenced appended hereto. The contents of all of these references are incorporated herein by reference.

Major advantages of the recycled IFOG over conventional IFOG include:
1) Reduced sense fiber length in order to reduce size and weight of the fiber sense coil.
2) Increase gyro performance as compared to conventional IFOG for the same fiber length.
3) Reduced gyro drift due to lower sense coil polarization cross talk.
4) Reduced SWaP of sense coil, with remote opto-electronics, enables the sense coil to be placed on platforms that might not be able to support the SWaP of an entire IFOG, plus the sense coil can be better isolated thermally from the opto-electronics

It is recognized that modifications and variations of the present invention will be apparent to those of ordinary skill in the art, and it is intended that all such modifications and variations be included within the scope of the appended claims.

### REFERENCES

1) Optical Engineering 47(3) 035007, March 2009
2) www.brimrose.com/ (IPM-500-100-5-1550-2FP)
3) J. Ruan et al, Proc. SPIE Vol. 7509, October 2009
4) Nature, 438, page 65, November 2005
5) Solid-State Electronics 51, page 1278, 2007

What is claimed is:

1. Interferometric fiber optic gyroscope comprising:
a pulsed light source for generating light pulses;
a sense coil for receiving and trapping the light pulses travelling in clockwise and counter clockwise directions for a selected number of times around the sense coil; and
a detector for receiving the counter propagating light pulses to determine the phase shift between the two counter propagating light pulses, the phase shift being proportional to rotation rate of the sense coil.

2. The gyroscope of claim 1 including a 2×2 coupler for receiving the light pulses and launching clockwise and counter clockwise beams into the sense coil.

3. The gyroscope of claim 1 including at least one optical switch for switching the light pulses into and out of the sense coil.

4. The gyroscope of claim 3 wherein the optical switch is electro-optic.

5. The gyroscope of claim 1 wherein the detector is time gated.

6. The gyroscope of claim 3 further including an additional optical switch or variable optical attenuator in the sense coil to suppress unwanted leakage light in the sense coil.

7. The gyroscope of claim 1 wherein the light pulses in the sense coil are multiplexed.

8. The gyroscope of claim 7 wherein the light pulses in the sense coil are time multiplexed.

9. The gyroscope of claim 7 wherein the light pulses in the sense coil are wavelength multiplexed.

10. The gyroscope of claim 7 wherein the light pulses in the sense coil are time and wavelength multiplexed.

11. The gyroscope of claim 1 wherein the gyroscope components are integrated on an optical chip.
